(19) United States
(12) Patent Application Publication
(10) Pub. No.: US 2024/0131913 A1
(43) Pub. Date: Apr. 25, 2024

(54) AUTOMOTIVE SUNSHADE WITH A MANUALLY RETRACTABLE DEVICE

(71) Applicant: Guangzhouyiqiandao Technology Co., Ltd, Guangzhou (CN)

(72) Inventor: Xinxing Yi, Shaoyang (CN)

(21) Appl. No.: 18/149,860

(22) Filed: Jan. 4, 2023

(30) Foreign Application Priority Data
Oct. 24, 2022 (CN) 202211311098.3

(51) Int. Cl. B60J 11/02

(52) U.S. Cl. CPC B60J 11/02

(57) ABSTRACT

An automotive sunshade with a manually retractable device comprises support bases, a housing, storage cavities, pull rods, extension rods, telescopic rods, a driving structure, and sunshade cloths; the housing is a detachable structure consisting of an upper housing, a right baffle, a left baffle and a bottom plate; the driving structure comprises a snap connecting piece, a torsion connecting rod, and a runner; one end of the torsion connecting rod is fixed with the snap connecting piece, and the other end is provided with the runner located on the left baffle; the snap connecting piece is provided with a slot; the upper housing comprises two storage cavities arranged symmetrically on the front and rear sides, and every storage cavity is provided with a storage reel; the storage reel is provided with a sliding track, and a connecting sliding strip is arranged in the sliding track.

### 1. TECHNICAL FIELD

The application relates to the field of automotive supplies, in particular to an automotive sunshade with a manually retractable device.

### 2. BACKGROUND ART

Nowadays, the vehicle ownership in China has grown very rapidly. Due to the scarcity of urban space, it is hard to build enough garages to park vehicles, for which many people have to park their vehicles on the roadside and outdoors. Every time in summer, the scorching sun continuously shines on the vehicles parked outdoors. Due to the high heat storage capacity of the metal housing of the vehicles, each vehicle is like an oven after a long period of exposure to the sun, which also intensifies the urban heat island effect.

The continuous heat increases the temperature inside the vehicle, even reaching above 60° C. Under such temperature, vehicle interior materials will continue to volatilize harmful substances, which will still be inhaled into the human body even after opening the door for ventilation, causing damage to human health.

In addition, the continuous exposure to the sun will cause serious aging of the internal and external materials of the vehicle, which not only increases the waste caused by replacing parts, but more seriously may cause the internal circuit of the vehicle to catch fire, causing the vehicle to spontaneously ignite and cause major accidents. Therefore, how to keep the vehicles parked outdoors from being exposed to the sun has become an urgent problem to be solved.

Aiming at the above problems, the prior art provides some solutions, such as setting a windshield sunshade device that can be stretched on the roof of the vehicle. Although it can provide shade for the vehicle, this device requires a storage space in the compartment, and needs to be stuck or tied to the vehicle roof when in use, which is inconvenient.

### 3. SUMMARY OF THE APPLICATION

The technical problem to be solved by the invention is to overcome the defects of the above technologies and provide an automotive sunshade with a manually retractable device.

In order to solve the above technical problems, the technical solution provided by the invention is an automotive sunshade with a manually retractable device, comprising support bases, a housing, storage cavities, pull rods, stoppers, extension rods, telescopic rods, springs, an intermediate baffle, a driving structure, and sunshade cloths; the housing is a detachable structure consisting of an upper housing, a right baffle, a left baffle and a bottom plate, the support base comprises suction cups, brackets and connecting members; the bottom of the bracket is in fixed connection with the suction cups, and the top of the bracket is provided with the connecting members that are in sliding connection with both sides of the bottom plate; the right baffle and the left baffle are provided with guide rods respectively, and the guide rods are provided with connecting holes;

the driving structure comprises a snap connecting piece, a torsion connecting rod, and a runner; one end of the torsion connecting rod is in fixed connection with the snap connecting piece, and the other end of the torsion connecting rod is provided with the runner; the runner is located on the left baffle and the runner is pivotally connected to the left baffle; the snap connecting piece is provided with a slot;

the upper housing comprises two storage cavities arranged symmetrically on the front and rear sides, and every storage cavity is provided with a storage reel; the top of the inner wall of the storage reel is provided with a convex body corresponding to the upper slot of the snap connecting piece, the storage reel is provided with a sliding track, and a connecting sliding strip is arranged in the sliding track; one end of the sunshade cloth is wound on the connecting sliding strip, and is connected with the storage reel through the sliding track, the other end of the sunshade cloth is fixedly connected with the pull rod; stoppers and extension rods are respectively arranged at both ends of the pull rod, cavities are respectively arranged at both ends of the pull rod, and the extension rod can do linear movement along the axis of the cavity.

Furthermore, a movable cleaning rod is provided on the left baffle.

Furthermore, two telescopic rods are arranged between the two storage cavities; one ends of the two telescopic rods are respectively flexibly connected with the right baffle and the left baffle, the other ends of the two telescopic rods are respectively provided with abutting springs, and an intermediate baffle is arranged between the two springs.

Furthermore, the right baffle and the left baffle are respectively provided with reset buttons, and each of the reset buttons is in fixed connection with an ejector rod; the ejector rod abuts against one end of a locking member, and the other end of the locking member abuts against the groove provided on the telescopic rod; the locking member is provided with a locking member spring and a connecting shaft connected by rotation, and the connecting shaft is connected with the guide rod through the connecting hole provided on the guide rod.

Furthermore, outer circumference of the runner is provided with anti-skid lines. Furthermore, the right baffle is provided with a support shaft, and the storage reel forms a rotating connection structure with the right baffle through the support shaft.

Compared with the prior art, the advantages of the application are:
(1) The structure design of this device is reasonable and convenient to use, which provides shelter for vehicles parked outdoors, avoiding the problem of high temperature inside the vehicle caused by the continuous sun shining, and reducing the cost of replacing the aging inner and outer parts of the vehicle due to the sunshine. More importantly, it avoids various safety hazards caused by long-term exposure to the sun.
(2) The device is easy to apply and operate. When in use, it can be fixed on the top of the vehicle through the suction cups, and the distance between the two support bases can be adjusted by moving the connecting part of the support base on the bottom plate. Then the pull rod can be pulled to drive the sunshade cloth to unfold, which can provide shelter for vehicles parked outdoors. When storage is required, turn the runner manually. Through the transmission of the torsion connecting rod and the snap connecting piece, the reel of the storage cavity is driven to rotate to realize the storage of the sunshade cloth.

### 4. BRIEF DESCRIPTION OF ACCOMPANY DRAWINGS

FIG. 1 is a perspective view of an automotive sunshade with a manually retractable device according to the invention;

FIG. 2 is a front view of the automotive sunshade with a manually retractable device according to the present invention;

FIG. 3 is a cross-sectional view of A-A in FIG. 2 of the automotive sunshade with a manually retractable device according to the invention;

FIG. 4 is a schematic diagram of the internal structure of the automotive sunshade with a manually retractable device according to the invention;

FIG. 5 is a cross-sectional view of the automotive sunshade with a manually retractable device according to the invention;

FIG. 6 is a structural schematic diagram of the driving structure of the automotive sunshade with a manually retractable device according to the invention;

FIG. 7 is an enlarged view of part Ain FIG. 6 of the automotive sunshade with a manually retractable device according to the invention;

FIG. 8 is a structural schematic diagram of the telescopic rod of the automotive sunshade with a manually retractable device according to the invention;

FIG. 9 is an enlarged view of part B in FIG. 8 of the automotive sunshade with a manually retractable device according to the invention;

FIG. 10 is a schematic diagram of the using effect of the automotive sunshade with a manually retractable device according to the invention;

FIG. 11 is a structural schematic diagram of the guide rod of the automotive sunshade with a manually retractable device according to the invention.

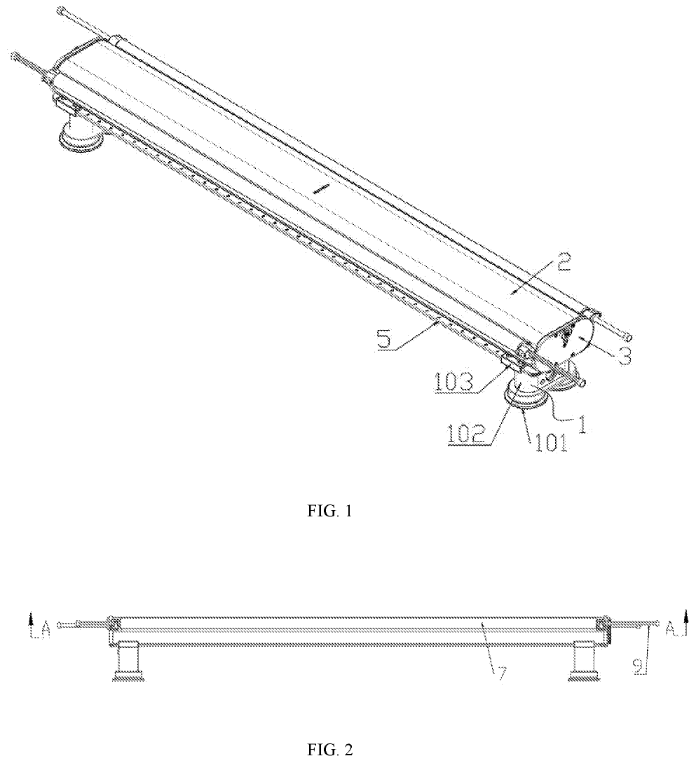

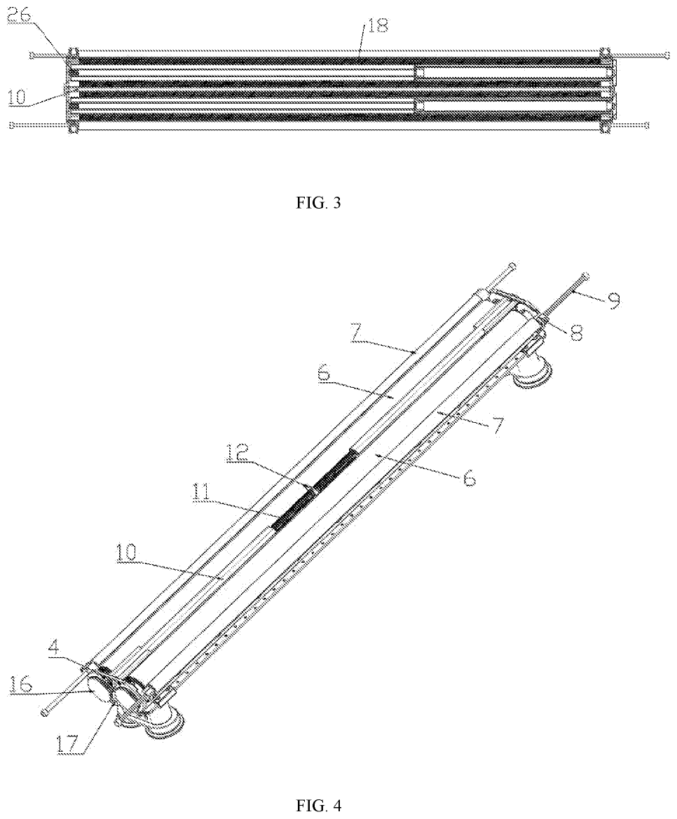

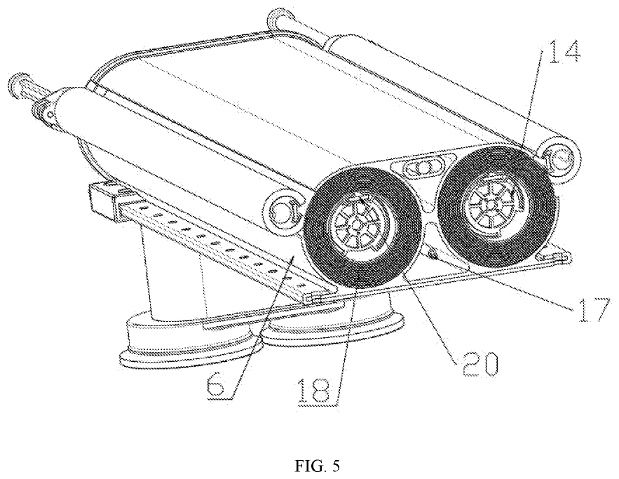

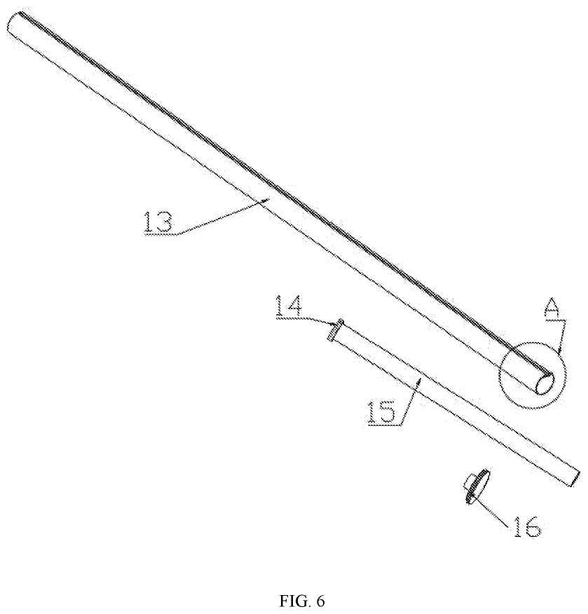

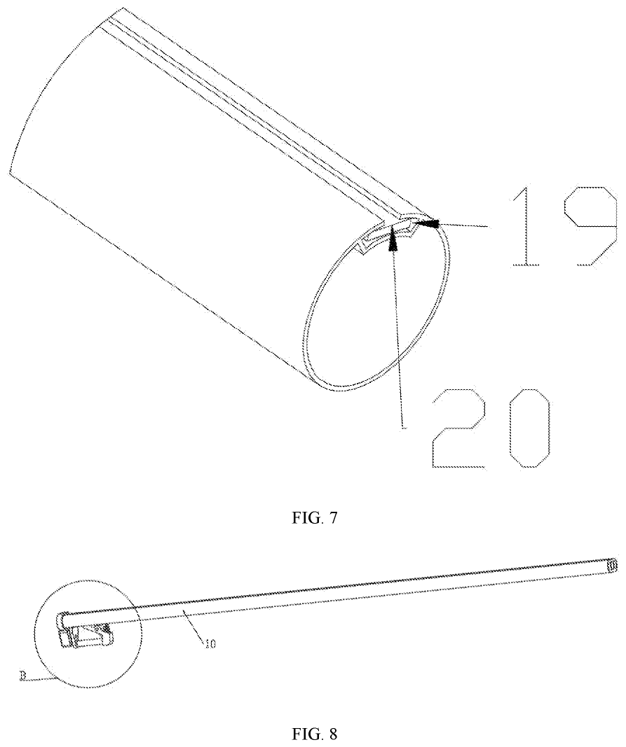

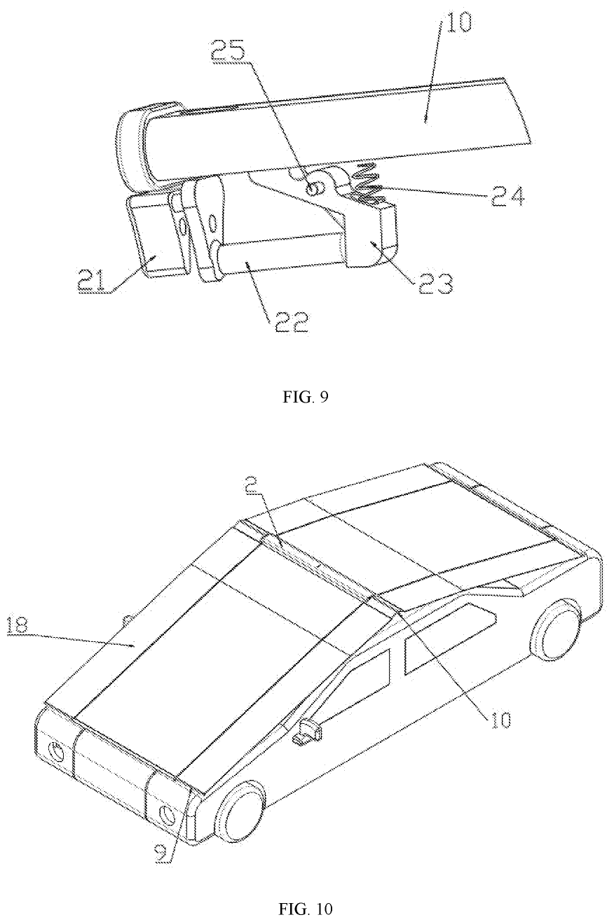

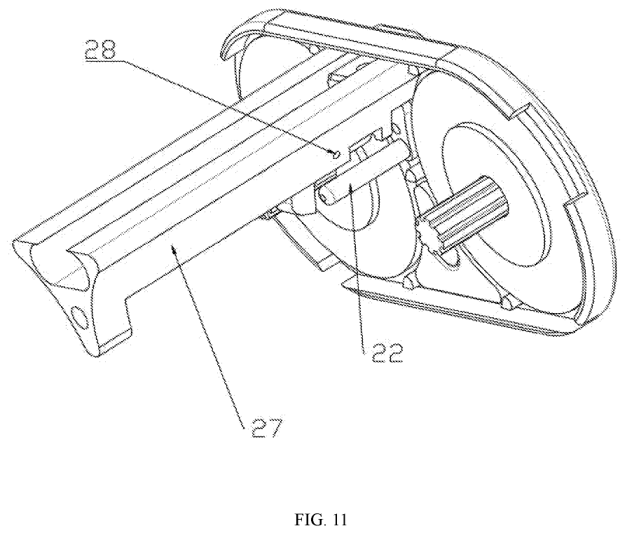

As shown in the figures: 1 refers to the support base, 101 refers to the suction cup, 102 refers to the bracket, 103 refers to the connecting member, 2 refers to the upper housing, 3 refers to the right baffle, 4 refers to the left baffle, 5 refers to the bottom plate, 6 refers to the storage cavity, 7 refers to the pull rod, 8 refers to the stopper, 9 refers to the extension rod, 10 refers to the telescopic rod, 11 refers to the spring, 12 refers to the intermediate baffle, 13 refers to the storage reel, 14 refers to the snap connecting piece, 15 refers to the torsion connecting rod, 16 refers to the runner, 17 refers to the cleaning rod, 18 refers to the sunshade cloth, 19 refers to the sliding track, 20 refers to the connecting sliding strip, 21 refers to the reset button, 22 refers to the ejector rod, 23 refers to the locking member, 24 refers to the locking member spring, 25 refers to the connecting shaft, 26 refers to the support shaft, 27 refers to the guide rod, 28 refers to the connecting hole.

### 5. SPECIFIC EMBODIMENT OF THE APPLICATION

With reference to the drawings, an automotive sunshade with a manually retractable device of the invention is further described in detail hereinafter.

With reference to the drawings, 1. An automotive sunshade with a manually retractable device, comprises support bases 1, a housing, storage cavities 6, pull rods 7, stoppers 8, extension rods 9, telescopic rods 10, springs 11, an intermediate baffle 12, a driving structure, and sunshade cloths 18; the housing is a detachable structure consisting of an upper housing 2, a right baffle 3, a left baffle 4 and a bottom plate 5, the support base 1 comprises suction cups 101, brackets 102 and connecting members 103; the bottom of the bracket 102 is in fixed connection with the suction cups 101, and the top of the bracket 102 is provided with the connecting members 103 that are in sliding connection with both sides of the bottom plate 5; the right baffle 3 and the left baffle 4 are provided with guide rods 27 respectively, and the guide rods 27 are provided with connecting holes 28;

the driving structure comprises a snap connecting piece 14, a torsion connecting rod 15, and a runner 16; one end of the torsion connecting rod 15 is in fixed connection with the snap connecting piece 14, and the other end of the torsion connecting rod 15 is provided with the runner 16; the runner 16 is located on the left baffle 4 and the runner 16 is pivotally connected to the left baffle 4; the snap connecting piece 14 is provided with a slot;

the upper housing 2 comprises two storage cavities 6 arranged symmetrically on the front and rear sides, and every storage cavity 6 is provided with a storage reel 13; the top of the inner wall of the storage reel 13 is provided with a convex body corresponding to the upper slot of the snap connecting piece 14, the storage reel 13 is provided with a sliding track 19, and a connecting sliding strip 20 is arranged in the sliding track 19; one end of the sunshade cloth 18 is wound on the connecting sliding strip 20, and is connected with the storage reel 13 through the sliding track 19, the other end of the sunshade cloth 18 is fixedly connected with the connecting sliding strip in the sliding track on the pull rod 7; stoppers 8 and extension rods 9 are respectively arranged at both ends of the pull rod 7, cavities are respectively arranged at both ends of the pull rod 7, and the extension rod 9 can do linear movement along the axis of the cavity.

As a preferred scheme of the embodiment, a movable cleaning rod 17 is provided on the left baffle 4.

As a preferred scheme of the embodiment, two telescopic rods 10 are arranged between the two storage cavities 6; one ends of the two telescopic rods 10 are respectively flexibly connected with the right baffle 3 and the left baffle 4, the other ends of the two telescopic rods 10 are respectively provided with abutting springs 11, and an intermediate baffle 12 is arranged between the two springs 11.

As a preferred scheme of the embodiment, the right baffle 3 and the left baffle 4 are respectively provided with reset buttons 21, and each of the reset buttons 21 is in fixed connection with an ejector rod 22; the ejector rod 22 abuts against one end of a locking member 23, and the other end of the locking member 23 abuts against the groove provided on the telescopic rod 10; the locking member 23 is provided with a locking member spring 24 and a connecting shaft 25 connected by rotation, and the connecting shaft 25 is connected with the guide rod 27 through the connecting hole 28 provided on the guide rod 27.

As a preferred scheme of the embodiment, the outer circumference of the runner 16 is provided with anti-skid lines.

As a preferred scheme of the embodiment, the right baffle 3 is provided with a support shaft 26, and the storage reel 13 forms a rotating connection structure with the right baffle 3 through the support shaft 26.

In specific implementation of the invention, when in use, the device can be fixed on the roof of the vehicle through the suction cups 101. The bottom plate 5 is made of soft rubber, which is used to prevent damage to the vehicle body when the device collides with the vehicle body. Meanwhile, the connecting members 103 of the support base 1 can move along both sides of the bottom plate 5, thereby adjusting the distance between the two support bases 1 to meet the installation requirements of vehicles of different widths.

When the sunshade cloths 18 need to be unfolded, pull the two pull rods 7 to the front and rear of the vehicle respectively to drive the sunshade cloths 18 to unfold. Then release the stoppers 8, pull out the extension rods 9, and press the reset buttons 21, making the telescopic rods 10 stretch out, then the telescopic rods 10 will be fixed under the locking action of the locking members 23, and the extension rods 9 will be fixed under the clamping action of the stopper 8. Then connect the sunshade cloths 18 with the extension rods 9 and the telescopic rods 10 respectively, and connect the pull rods 7 with the vehicle body through the rope, so as to realize the complete unfolding and fixing of the sunshade cloths 18, thus providing shelter for vehicles parked outdoors.

When the sunshade cloths 18 needs to be stored, first disconnect the sunshade cloths 18 from the extension rods 9 and the telescopic rods 10, release the stoppers 8 to retract the extension rods 9, and compress the stoppers 8 to prevent the extension rods from slipping out. Then press the reset buttons 21, and the locking members 23 will break away from the connection with the telescopic rods 10 under the action of the ejector rods 22. Then retract the telescopic rods 10, and manually rotate the runner 16. Through the transmission action of the torsion connecting rod 15 and the snap connecting piece 14, the storage reels 13 can be driven to rotate, thereby realizing the retraction and storage of the sunshade cloths.

When sundries such as leaves and bird droppings fall on the sunshade cloths 18, the cleaning rod 17 can be pulled out to clean the sundries attached to the sunshade cloths 18.

The device structure provides shelter for vehicles parked outdoors, avoiding the problem of high temperature inside the vehicle caused by the continuous sun shining, and reducing the cost of replacing the aging inner and outer parts of the vehicle due to the sunshine. More importantly, it avoids various safety hazards caused by long-term exposure to the sun. Additionally, its usage and storage are both convenient, saving time as well as effort.

The invention and its embodiments have been described above, but the description is not restrictive. What is shown in the accompanying drawings is only one of the embodiments of the invention, and the actual structure is not limited thereto. All in all, if those of ordinary skill in the art are inspired by it, without departing from the purpose of the invention, any structural modes and embodiments similar to this technical solution designed without creativity should fall within the protection scope of the invention.

1. An automotive sunshade with a manually retractable device, comprises support bases (1), a housing, storage cavities (6), pull rods (7), stoppers (8), extension rods (9), telescopic rods (10), springs (11), an intermediate baffle (12), a driving structure, and sunshade cloths (18); the housing is a detachable structure consisting of an upper housing (2), a right baffle (3), a left baffle (4) and a bottom plate (5), the support base (1) comprises suction cups (101), brackets (102) and connecting members (103); the bottom of the bracket (102) is in fixed connection with the suction cups (101), and the top of the bracket (102) is provided with the connecting members (103) that are in sliding connection with both sides of the bottom plate (5); the right baffle (3) and the left baffle (4) are provided with guide rods (27) respectively, and the guide rods (27) are provided with connecting holes (28);
the driving structure comprises a snap connecting piece (14), a torsion connecting rod (15), and a runner (16); one end of the torsion connecting rod (15) is in fixed connection with the snap connecting piece (14), and the other end of the torsion connecting rod (15) is provided with the runner (16); the runner (16) is located on the left baffle (4) and the runner (16) is pivotally connected to the left baffle (4); the snap connecting piece (14) is provided with a slot;
the upper housing (2) comprises two storage cavities (6) arranged symmetrically on the front and rear sides, and every storage cavity (6) is provided with a storage reel (13); the top of the inner wall of the storage reel (13) is provided with a convex body corresponding to the upper slot of the snap connecting piece (14), the storage reel (13) is provided with a sliding track (19), and a connecting sliding strip (20) is arranged in the sliding track (19); one end of the sunshade cloth (18) is wound on the connecting sliding strip (20), and is connected with the storage reel (13) through the sliding track (19), the other end of the sunshade cloth (18) is fixedly connected with the pull rod (7); stoppers (8) and extension rods (9) are respectively arranged at both ends of the pull rod (7), cavities are respectively arranged at both ends of the pull rod (7), and the extension rod (9) can do linear movement along the axis of the cavity.

2. The automotive sunshade with a manually retractable device according to claim 1, wherein a movable cleaning rod (17) is provided on the left baffle (4).

3. The automotive sunshade with a manually retractable device according to claim 1, wherein two telescopic rods (10) are arranged between the two storage cavities (6); one ends of the two telescopic rods (10) are respectively flexibly connected with the right baffle (3) and the left baffle (4), the other ends of the two telescopic rods (10) are respectively provided with abutting springs (11), and an intermediate baffle (12) is arranged between the two springs (11).

4. The automotive sunshade with a manually retractable device according to claim 1, wherein the right baffle (3) and the left baffle (4) are respectively provided with reset buttons (21), and each of the reset buttons (21) is in fixed connection with an ejector rod (22); the ejector rod (22) abuts against one end of a locking member (23), and the other end of the locking member (23) abuts against the groove provided on the telescopic rod (10); the locking member (23) is provided with a locking member spring (24) and a connecting shaft (25) connected by rotation, and the connecting shaft (25) is connected with the guide rod (27) through the connecting hole (28) provided on the guide rod (27).

5. The automotive sunshade with a manually retractable device according to claim 1, wherein the outer circumference of the runner (16) is provided with anti-skid lines.

6. The automotive sunshade with a manually retractable device according to claim 1, wherein the right baffle (3) is provided with a support shaft (26), and the storage reel (13) forms a rotating connection structure with the right baffle (3) through the support shaft (26).
